(19) United States
(12) Patent Application Publication
(10) Pub. No.: US 2019/0304029 A1
(43) Pub. Date: Oct. 3, 2019

(54) SYSTEMS AND METHODS FOR MANAGING COMPANY EXPENSES

(71) Applicant: Divvy Pay LLC, Lehi, UT (US)

(72) Inventors: Blake Murray, Sandy, UT (US); Alex Bean, Orem, UT (US); Gregory Larson, Lehi, UT (US)

(21) Appl. No.: 15/941,642

(22) Filed: Mar. 30, 2018

(51) Int. Cl. G06Q 40/00; G06Q 20/34

(52) U.S. Cl. CPC G06Q 40/12; G06Q 20/34

(57) ABSTRACT

A system and method for authorizing, managing, and tracking expenses made by an agent on behalf of a principal is disclosed. The principal assigns a budget to the agent including parameters describing permitted expenditures. The agent requests of the principal via a Transaction Authorization System authorization for an expenditure. If the principal authorizes, the agent is permitted to make the transaction. The transaction is described and categorized by the agent via the Transaction Authorization System and information from the transaction, the budget, and the request process is compiled into a report.

### BACKGROUND

Many companies' current methods of tracking expenses is cumbersome and outdated. Most companies use standard-issue credit cards which are handed out to employees with verbal instructions on how or what to spend. Most companies do not control employee spending except for monitoring expenses after they have been incurred—when it is too late to do anything about any problems. Many employees have zero ability to spend money on behalf of the company because the process of monitoring and tracking expenses, and the trust required to execute properly, are not in place. Another method of tracking expenses is by requiring employees to keep physical receipts, turn them in, and wait for a reimbursement. Another inefficiency of current company spending is loyalty rewards which card issuers provide are benefits which flow to the employee, not the company paying the bill. A new way to track expenses and monitor employee activity is required.

### BRIEF DESCRIPTION OF THE FIGURES

FIG. 1 is a block diagram of an operating environment for implementations of computer-implemented methods according to embodiments of the present disclosure.

FIG. 2 is a swim lane diagram of a process by which a company or organization can approve, authorize, and report expenditures made by an employee according to embodiments of the present disclosure.

FIG. 3 is a swim lane diagram of a process by which a company or organization can approve, authorize, and report expenditures made by an employee according to embodiments of the present disclosure.

FIG. 4 is a flowchart diagram of a method for using the expense management services according to embodiments of the present disclosure.

FIG. 5 is a flowchart diagram of a method similar to the method described with reference to FIG. 4 from the perspective of a central system according to embodiments of the present disclosure.

FIG. 6 is a schematic representation of a relationship between an employer, employee, merchant, card holder, and a Transaction Authorization System according to embodiments of the present disclosure.

FIG. 7 is a schematic diagram of a Transaction Authorization System according to embodiments of the present disclosure.

FIG. 8 is another schematic diagram of a budgeting system according to embodiments of the present disclosure.

### SUMMARY

Embodiments of the present disclosure are directed to a system for managing expenditures using a card. The system includes a budgeting module configured to receive a budget having a plurality of parameters describing conditions under which the card may be used, and a communications module configured to transmit the parameters to a card issuer. The card issuer issues the card, manages expenditures made with the card, and maintains an account pertaining to the card. The card issuer reconfigures the account according to the parameters such that expenditures are allowed so long as the expenditures are made according to the parameters. In some embodiments the system also includes expenditure module configured to receive a selection of one or more budgets and inform the card issuer of the selection. The card issuer reconfigures the account according to the parameters of the selected budget.

In other embodiments the present disclosure is directed to a method for managing expenses, including establishing an account and issuing a card for making purchases using the account, and receiving one or more budgets. Individual budgets include a plurality of parameters dictating conditions for use of the card. The budgets and parameters are stored in a memory. The method also includes receiving a selection of a budget, accessing the parameters in the budget from the memory, and reconfiguring the account according to the parameters in the selected budget.

In yet other embodiments the present disclosure is directed to a method including receiving one or more budgets, wherein individual budgets have one or more parameters. The parameters identify conditions under which a transaction can be made using a card, and the parameters include at least a maximum credit line associated with an account from which the card draws, and a time during which the budget is active. The method also includes receiving a selection of a budget from among the budgets, and when the time is reached, applying the parameters from the selected budget to reconfigure the account. The method also includes receiving transaction details from a point of sale, and if the transaction details are in accordance with the parameters in the selected budget, allowing the transaction to be executed.

### DETAILED DESCRIPTION

Below is a detailed description according to various embodiments of the present disclosure. Certain embodiments are given with examples but it is to be understood that the scope of the present disclosure is not limited to a specific example. Rather, the present disclosure encompasses many alternatives which are understood by a person of ordinary skill in the art.

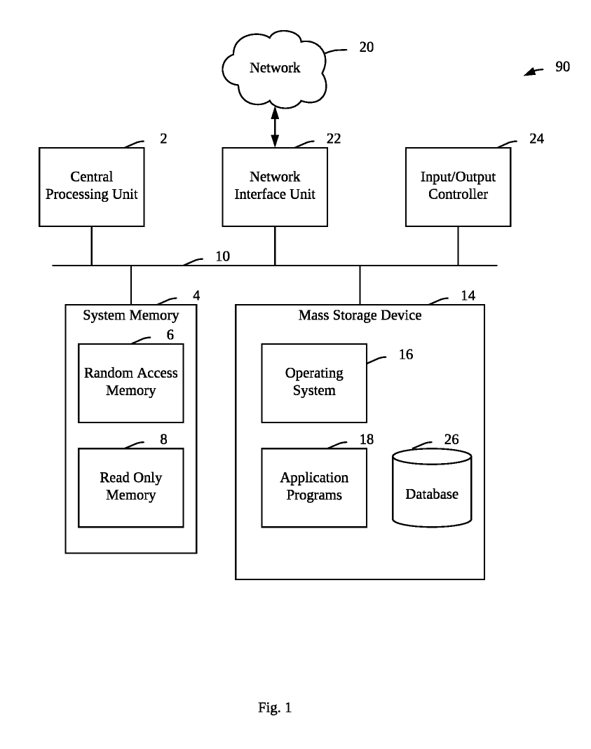

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 90 utilized in the various embodiments will be described. The computer architecture shown in FIG. 1 may be configured as a desktop or mobile computer and includes a central processing unit 2 (“CPU”), a system memory 4, including a random access memory 6 (“RAM”) and a read-only memory (“ROM”) 8, and a system bus 10 that couples the memory to the CPU 2.

A basic input/output system containing the basic routines that help to transfer information between elements within the computer, such as during startup, is stored in the ROM 8. The computer 90 further includes a mass storage device 14 for storing an operating system 16, application programs 18, and other program modules, which will be described in greater detail below.

The mass storage device 14 is connected to the CPU 2 through a mass storage controller (not shown) connected to the bus 10. The mass storage device 14 and its associated computer-readable media provide non-volatile storage for the computer 90. Although the description of computer-readable media contained herein refers to a mass storage device, such as a hard disk or CD-ROM drive, the computer-readable media can be any available media that can be accessed by the computer 90. The mass storage device 14 can also contain one or more databases 26.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 90.

According to various embodiments, computer 90 may operate in a networked environment using logical connections to remote computers through a network 20, such as the Internet. The computer 90 may connect to the network 20 through a network interface unit 22 connected to the bus 10. The network connection may be wireless and/or wired. The network interface unit 22 may also be utilized to connect to other types of networks and remote computer systems. The computer 90 may also include an input/output controller 24 for receiving and processing input from a number of other devices, including a keyboard, mouse, or electronic stylus (not shown in FIG. 1). Similarly, an input/output controller 24 may provide output to a display screen, a printer, or other type of output device (not shown).

As mentioned briefly above, a number of program modules and data files may be stored in the mass storage device 14 and RAM 6 of the computer 90, including an operating system 16 suitable for controlling the operation of a networked personal computer. The mass storage device 14 and RAM 6 may also store one or more program modules. In particular, the mass storage device 14 and the RAM 6 may store one or more application programs 18.

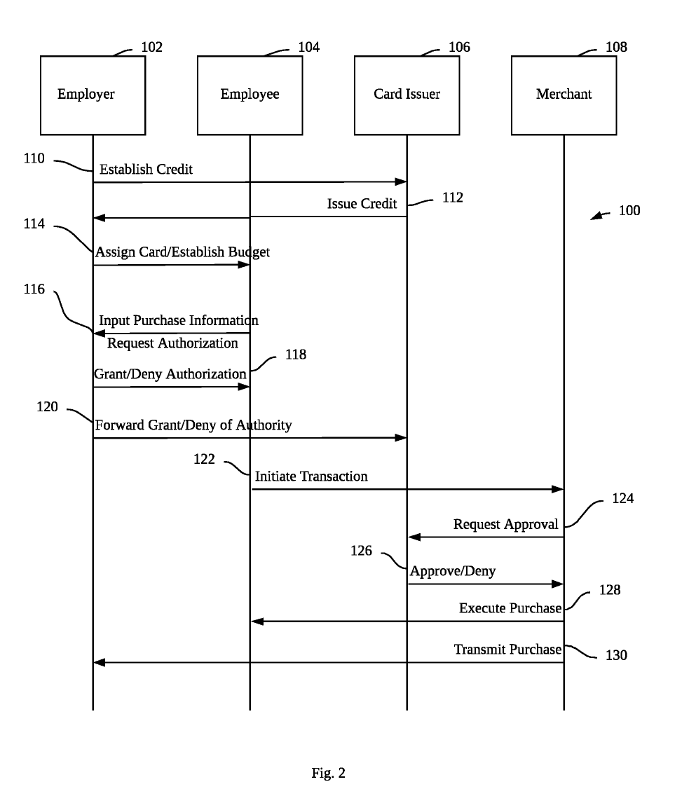

FIG. 2 is a swim lane diagram of a process 100 by which a company or organization 102 can approve, authorize, and report expenditures made by an employee 104. The process 100 involves an employer 102, and employee 104, a card issuer 106, and a merchant 108. The employer 102 can be any individual or organization such as a company, an organization within a company, an organization, a community group, an individual, or any other suitable entity. The employer 104 can be a traditional for-hire employee, a contractor, a volunteer, an organization, or a group of individuals. The employee 104 is the agent to the employer's 102 principle. For purposes of discussion, the terms employer and employee are used without limiting the scope of the present disclosure. The card issuer 106 can be a credit-issuing agency such as VISA™ or MASTERCARD™ CoreCard™, FirstView Financial™, FIS™, Fisery Inc™, Global Processing Services™, or another suitable agency capable of issuing credit. Most commonly, the card issuer 106 will deliver a standard credit card with a magnetic strip or an electronic chip. The present disclosure, however, also includes the use of virtual cards or support for other transactions such as “card-not-present” transactions without departing from the spirit of the disclosure. The merchant 108 can be any entity, organization, or company equipped to effect a sale of goods or services. This can include a physical brick-and-mortar store or a virtual retailer or any other entity. For purposes of simplicity and clarity the terms merchant and card issuer are used here in a non-limiting sense.

The process 100 according to the present disclosure begins by establishing credit 110 between the employer 102 and the card issuer 106. The card issuer 106 issues credit 112 back to the employer 102. This is the basis of trust between the employer 102 and the card issuer 106 who will ultimately supply the funds for any transaction executed on the basis of the credit. Once the employer 102 has established credit, the employer 102 can assign a card/establish a budget 114 to the employee 104. This can be done by physically delivering a credit card to the employee 104, by issuing a virtual card to the employee 104, or by allocating a budget to the employee 104. The budget can have attributes such as purchase amount, timing of purchase, reason for purchase, number of uses, accepted vendors (can be defined specifically or generally i.e. “travel purchases allowed”), accepted locations (specific or general), maximum limit per transaction (sum of multiple purchases), recurrences/schedule, required persons present for transaction, etc.

Before the employer 102 establishes the budget 114, the card held by the employee 104 is incapable of making purchases. The card can have zero value and swiping the card at a point of sale (POS) can result in a denied transaction or otherwise have zero effect. In some embodiments, swiping the card before having an established budget does not make a call to the card issuer 106 or any other entity. Without the budget established, the card is incapable of making purchases. This operates to prevent unauthorized purchases, prevent fraud, and to cabin the discretion of employees. In some embodiments the card itself is reconfigured in response to the budget selection. The budget is established by the employer at a computing device, mobile or stationary, and that computing device and associated software is configured to transmit the information to the party responsible for managing the card. It may be the card issuer or an underwriter, but for the sake of clarity this party is referred to herein as the card issuer. The budget information reaches the card issuer and the card information is changed according to the budget. By providing meaningful limits on unauthorized purchases—deliberately fraudulent charges and accidental charges alike—employers can have greater confidence in their employees and will be more likely to authorize their employees to act on behalf of the company.

The process 100 continues by the employee 104 requesting authorization for a purchase. In some embodiments, this can be achieved by using an app on a mobile device, such as an IPHONE™ or an ANDROID™ device. The employee 104/user can open the app and select a budget which has been established. The user can be required to input certain information into the app such that the budget is invoked for the purchase. Once sufficient information has been entered via the mobile app, the employer 102 can authorize or deny 118 the transaction. In some embodiments the budget is preauthorized by the employer upon establishing the budget. Now the user's card is allowed to make the transaction which can be done by funding an account, activating the card, removing a restriction from the card, etc. The employer 102 also forwards the authorization to the card issuer 106 at 120 to allow the card issuer 106 to enable the card to make the transaction. The transaction is then initiated at 122 by a swipe or inserting a chipped card into a reader, etc. The Merchant 108 can then request authorization 124 for the transaction which is approved or denied 126 by the issuer 106. The purchase is then executed 128. After the purchase, the details of the purchase are transmitted back to the employee 102. After the purchase, the card can be returned to the same inoperative state it was in before the transaction was authorized. The same or different restrictions or characteristics can be applied again after the transaction takes place. The process 100 described here allow employees to make authorized purchases quickly and with confidence without risk of unauthorized purchases, and the employer can have confidence that the card cannot be used outside of the bounds of the authorization process set forth above.

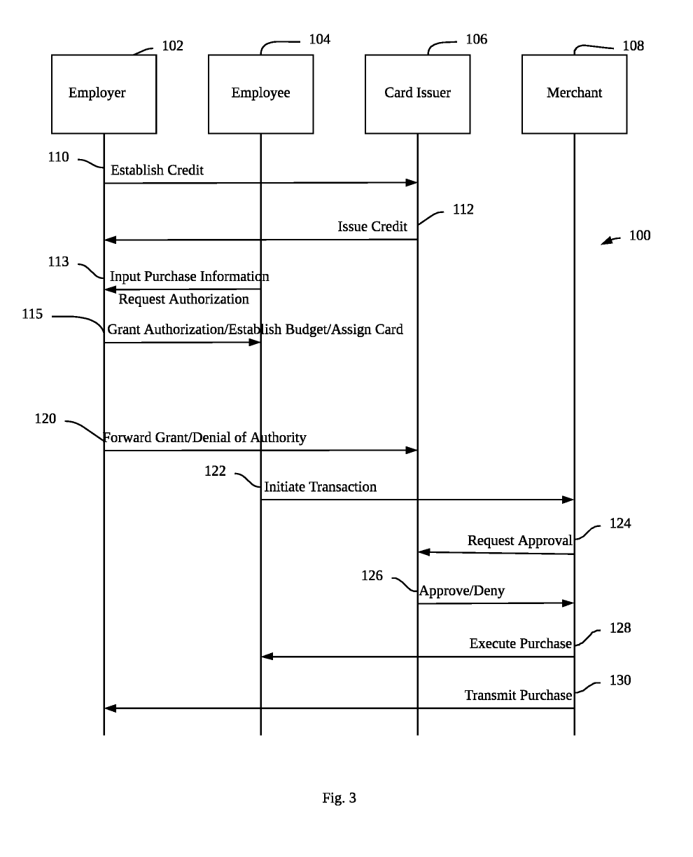

FIG. 3 is a swim lane diagram showing a process according to embodiments of the present disclosure. Many features shown in FIG. 3 are generally similar to features of FIG. 2, including the employer 102, employee 104, card issuer 106, and merchant 108. According to embodiments of FIG. 3, establishing credit 110 and issuing credit 112 are generally similar to the process described above. Once credit has been established, the process includes inputting purchase information 113. This step can be carried out by the employee 104 using a smartphone or other computing device to describe a purchase in terms of category, amount, time, etc. as has been described above. The employee 104 can submit the purchase request and request authorization from the employer 102. In response to receiving this request, the employer 102 can grant authority 115. This portion of the process can also include establishing a budget and assigning a card. In this manner, the employee 104 is able to submit a request for a budget and funds for a purchase that was not necessarily envisioned by the employer 102 beforehand, but the employer 102 still has the ability to approve or deny the request. Once the decision has been made by the employer 102 he can forward the grant or denial of authority at 120 and the remainder of the process can be similar to what was described above in FIG. 2.

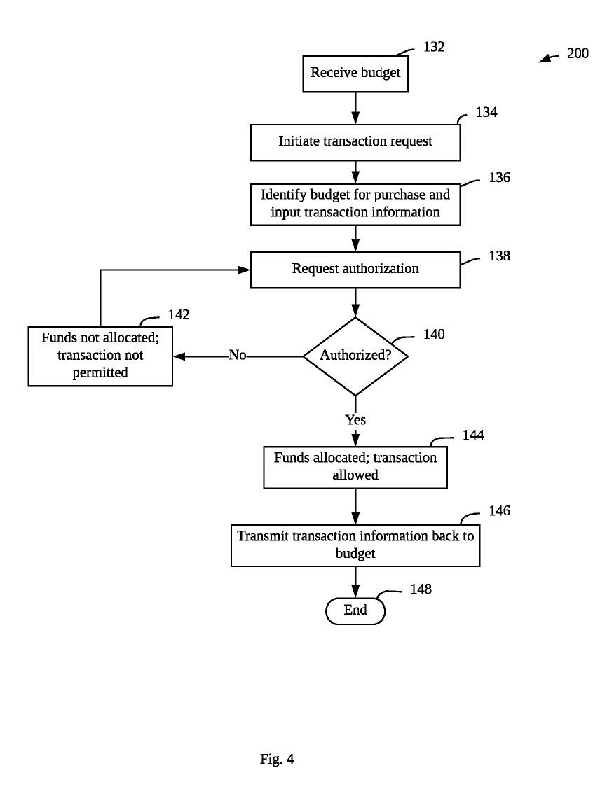

FIG. 4 is a flowchart diagram of a method 130 for using the expense management services according to embodiments of the present disclosure. The method 130 is seen from the perspective of the employee described in FIG. 1. At step 132 the method 130 begins by receiving a budget. The budget can be anything the employer wishes to track, such as office supplies, meals, hotels, etc. For example, the employee can receive a budget of $100.00 for a car rental. Once the budget is received, funds for purchases are authorized according to the description of the budget. The employee then initiates a transaction request at 134. This can be achieved using a smartphone such as an Apple IPHONE or an ANDROID device or another suitable terminal including a personal computer or even a touch-tone telephone. The transaction request consists of selecting a budget which the user wishes to use. The user may have multiple available budgets at any given time. Continuing our example of the car rental, suppose the user arrives at the desk to pay for a car rental. The user can activate the mobile app and select the car rental budget. This is the step of initiating the budget for purchase and inputting transaction information step at 136. The user submits the request to activate the funds for the selected budget at 138. A central system (not shown) receives the request and authorizes or denies the request. It is possible for transactions to be pre-authorized via the central system ahead of time. The user awaits an authorized/denial decision at 140. If denied, the transaction is not permitted and the method waits until another request is submitted. If the transaction is authorized, funds can be allocated to the card, which can be a physical card or a virtual card at 144 and the transaction is consummated. The user can spend up to $100.00 (or another predetermined allotted amount) for the car rental. After the transaction is complete, information describing the transaction are instantly transmitted to the central system for tracking and reporting at 146. The method 130 ends at 148.

The method 130 described above permits the user to pay for business expenses according to the exact wishes of his employer, without risking fraud or negligent use of a card by an employee. In the case of a virtual card, there is no card to lose or to be stolen. The virtual cards can be created by the central system as the user requests authorization so the window of time during which the virtual card can be used is minimized, further limiting the potential for fraud. The method 130 also eliminates the need for keeping receipts, reimbursements, and expense reports.

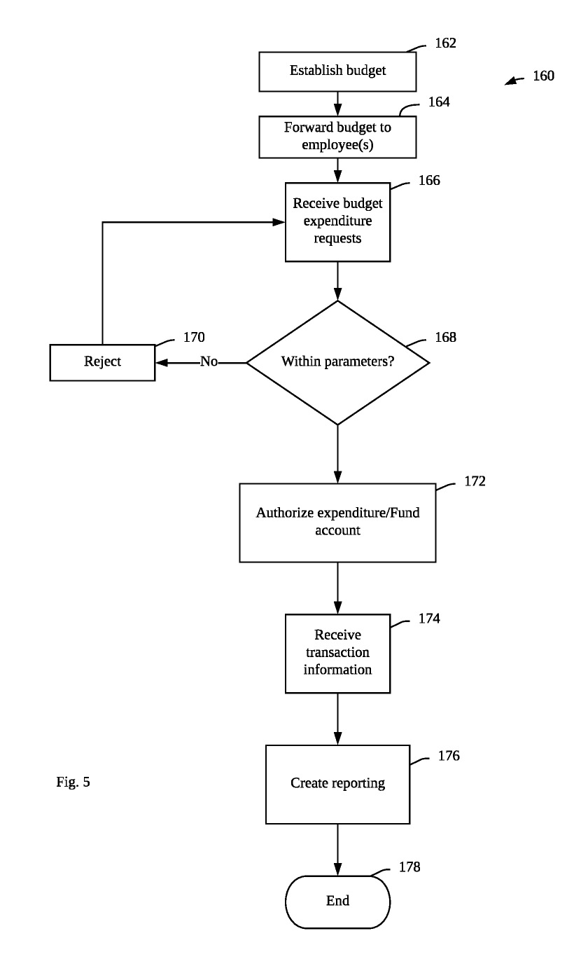

FIG. 5 is a flowchart diagram of a method 160 similar to the method described with reference to FIG. 3 from the perspective of a central system (not shown). The central system can be a server or another suitable computer or network of computers including databases, networking components, and processors configured to execute a series of commands according to the methods of the present disclosure. At 162 the method includes establishing a budget. The budget can be for anything the company or employee needs to purchase. The budget is forwarded to the employee at 164. The employee can submit a budget access request which is received at 166. The central system can check the budget request to determine whether or not it is within parameters set by the system at 168. If not, the method 160 can include rejecting the request at 170. The parameters can be exceeded if the system determines the employee is sufficiently trustworthy to make a business decision at the time of the transaction. The degree to which the expenditure differs from the prescribed budget can be another attribute of the budget. For example, one employee may be given a strict budget because she is a new employee or because funds are limited. Another employee may be given wide latitude to exceed a budget constraint due to a track record of success. At 172 the authorization has been made and the expenditure is authorized. In some embodiments this can mean that the account is funded at this time and not before. In other embodiments the card is rendered operational at this step and not before. Attempts to swipe the card prior to this authorization will be unsuccessful. In some embodiments an unsuccessful attempt can mean a call to a card issuer via the point of sale terminal. In other embodiments the card itself is not operable to initiate the swipe until the authorization is received. In still further embodiments the card is a virtual card and it is not issued until receiving this authorization step at 172. In this case there is no card, no card number, and therefore no ability to initiate the transaction until the authorization is made.

Step 174 takes place after the transaction is consummated between the card holder and the merchant at the point of sale (or via a card-not-present transaction) and the central system receives details of the transaction. At 176 this information is compiled into a report including the information from the merchant such as amount, time of sale, Standard Industrial Classification (SIC) numbers, Merchant Category Code (MCC), etc. The information can also include the selection made by the card holder/employee during the request for information received at 166 described additionally with regard to FIG. 2. This reporting information can be delivered into any suitable format, including an Internal Revenue Service—ready report. At 178 the method ends. The process can repeat as often as necessary at the discretion of the card holder.

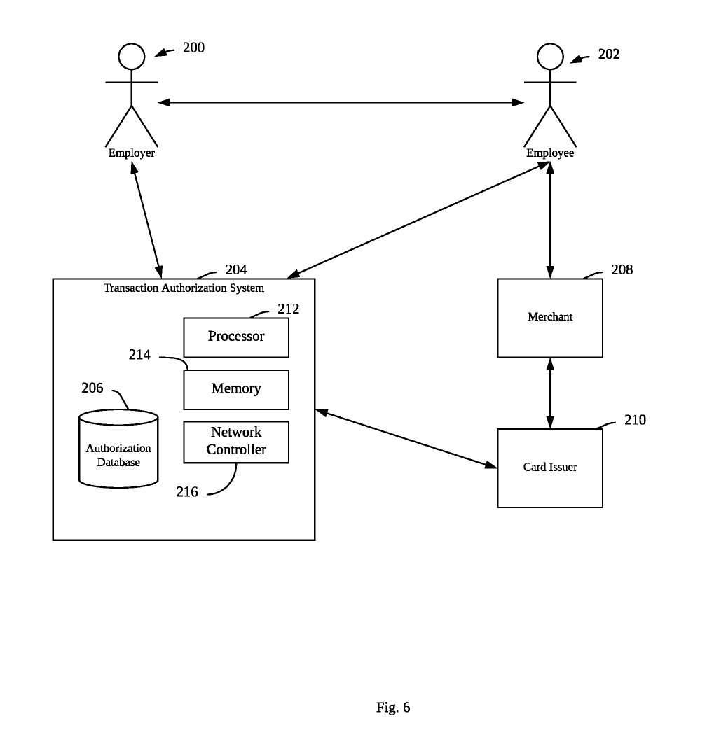

FIG. 6 is a schematic representation of a relationship between an employer, employee, merchant, card holder, and a Transaction Authorization System according to embodiments of the present disclosure. An employer 200 and an employee 202 have a principal-agent relationship under which the employee 202 acts on behalf of the employer 200. As discussed elsewhere herein, the terms employee and employer are used for simplicity and any entity, individual, or organization can be considered the principal or agent as the case may be. The employer 200 can utilize a Transaction Authorization System 204. The Transaction Authorization System 204 can consist of one or more computers or computer networks operating together to execute commands from the employer 200. In some embodiments, the Transaction Authorization System 204 is a server operating at a location remote from the employer 200 and is a service provided by a company such as DIVVY. In other embodiments, the Transaction Authorization System 204 is operated in-house by the employer 200. The Transaction Authorization System 204 includes an Authorization Database 206, a processor 212, memory 214, and a network controller 216 configured to interface with networks such as the INTERNET or a telephone network or another suitable communication platform. Through the network controller 216, the Transaction Authorization System 204 can communicate with a card issuer 210 to provide details of a transaction to permit the card issuer to allow or deny transactions.

The Authorization Database 206 can store budgets as directed by the employer 200. A budget can be for any purpose and can have constraints which control access to funds for purchases. The employer 200 can assign a budget to the employee 202 for a specific amount, purpose, time, place, or any combination thereof. For example, the employer 200 can assign a budget to the employee to cover air fare. The employer 200 can, for example, specify that the employee must choose a certain carrier, the fare must be less than $500.00 and the purchase must be made no less than two weeks before the date of the flight. The employee 202 can search for air fare using a web browser or another suitable means, and once he has identified appropriate airfare, he can use a mobile device such as a smartphone or laptop computer to request from the Transaction Authorization System 204, which requires him to input certain information as described in the budget. Once the employee 202 does this, the Transaction Authorization System 204 ensures that the proposed purchase falls within the parameters of the budget. If so, the Transaction Authorization System can enable the purchase. This can be done by issuing a virtual card or by funding an account. This authorization is sent to the card issuer such that the purchase can be made. The employer can then use the card at the merchant 208 to effect the purchase. In this way, the transaction cannot be made until authorization comes from the Transaction Authorization System 204. Attempts to use the card prior to receiving authority will have no effect. In some embodiments it is impossible even to attempt to make a purchase because the virtual card has not come into existence yet. Fraud and accidental expenditures are therefore prevented. So, to, are expenditures above and beyond a prescribed budget. This feature allows employers to trust more employees with this purchasing ability without worrying about an untrustworthy employee overstepping limits.

One of the constraints within the budget can be the physical location of the mobile device from which the request is made. Furthermore, the distance between the physical location of the mobile device and the POS can be used to authorize a purchase. For example, as the employee inputs the request the mobile device can report the physical location of the mobile device to the Transaction Authorization System 204 which can also receive the physical location of the POS from the merchant 208 or from the card issuer 210. A distance between these two physical locations can be calculated and if the two locations are further away than a prescribed distance the transaction will not be authorized.

Another of the constraints within the budgets can be a trust factor for an employee. Certain employees are more trustworthy than others, so a numerical value representing trustworthiness can be assigned to an employee within a budget. For an employee with a high trustworthiness value, he may be granted discretion to exceed a budget whereas an employee with a lesser trustworthiness value will not.

In some embodiments, the Transaction Authorization System 204 can track the quantity and frequency of instances in which the employee is able to come in under budget and can provide this information to the employer so that the employer may reward the employee in a suitable manner. For example, if a budget is given for $100.00 and the employee is able to make a suitable purchase for $80.00 he has saved the company the difference. Over time these quantities can be reported to the employer 200. The employer 200 can take action on this number, either by adjusting the budgets to better suit the cost of the goods or services in question, to reward the employee 202, or both.

The Transaction Authorization System 204 can also receive information about the transaction from the card issuer 210 or the merchant 208 or both. The information can be compiled into a report showing what the transaction is, the amount, and the other information regarding the purchase which was entered during the pre-purchase request. Thus, expense reports are eliminated! Saving receipts for purchases is rendered entirely unnecessary, resulting in significant cost savings.

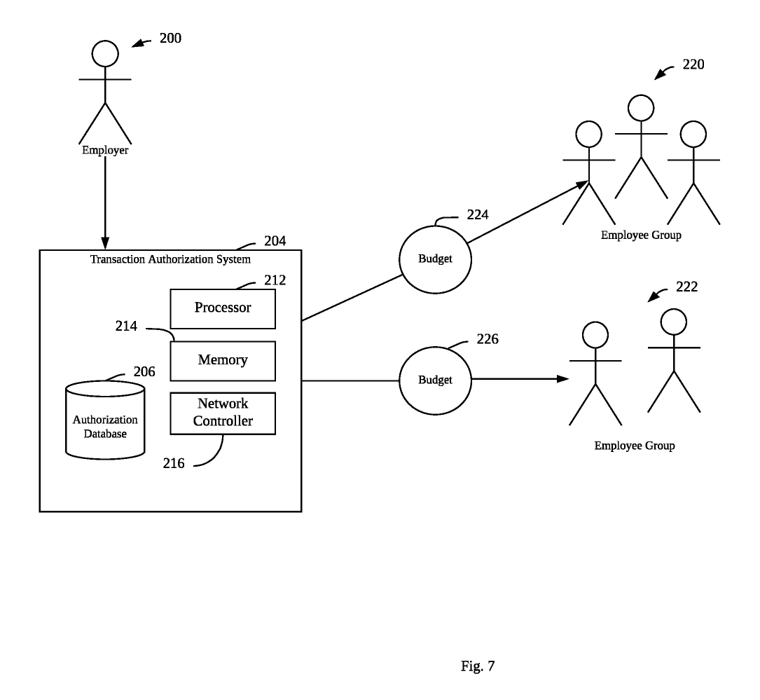

FIG. 7 is a schematic diagram of a Transaction Authorization System 204 according to embodiments of the present disclosure. In several embodiments the employer 200 can assign a budget such as 224 or 226 to a group of employees forming employee groups as represented at 220 and 222, respectively. There can be any number of groups, and individuals can be a part of more than one group. Employees can be given different responsibility for different features of the budget. For example, one employee in group 220 is assigned to arrange for air fare; another employee has hotels; and yet another has meals. Each expenditure can come out of a total expense amount, but the parameters and constraints governing each transaction can be different. The employer 200 can require authorization for each purchase, or he can batch-authorize several purchases ahead of time. The employer has ultimate control over the purchases of the groups including amount, time, place, vendor, etc. The Transaction Authorization System 204 can comprise a card issuer, underwriter, or another party responsible for carrying out purchases made with cards issued under its authority.

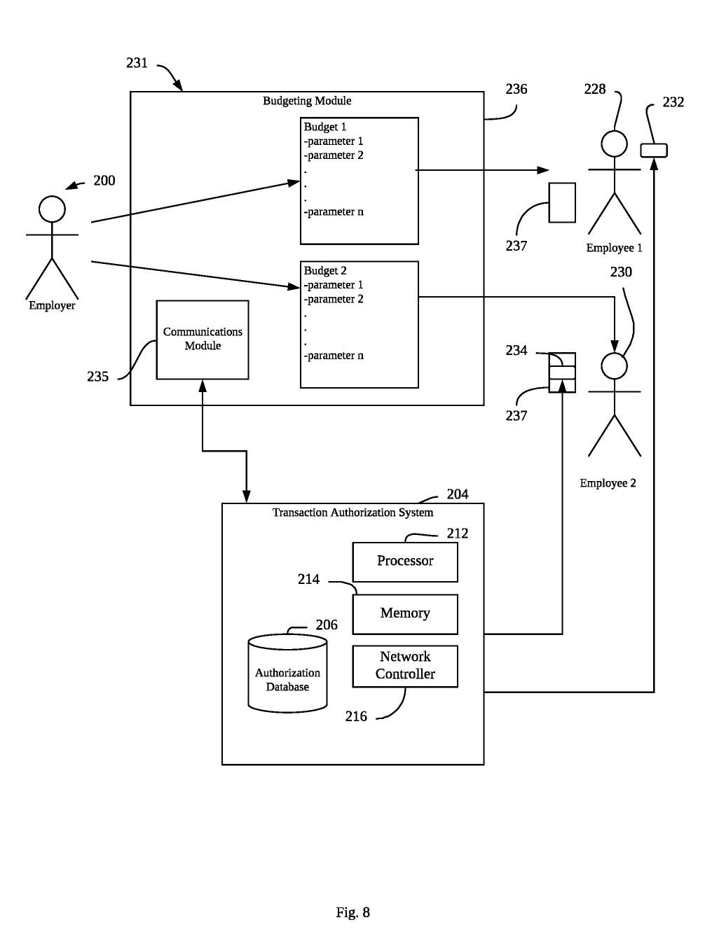

FIG. 8 is another schematic illustration of an embodiment of a budgeting system 231 according to the present disclosure. An employer 200 has authority to dictate what and how the employees 228, 230 spend. The employees have cards 232 and 234, respectively. The system 231 includes a budgeting module 236 which can comprise executable software in conjunction with corresponding hardware which is configured to carry out the budgeting controls described herein. The budgeting module 236 allows the employer 200 to create budgets that can contain parameters that dictate the capabilities and limitations of the cards 232, 230. The parameters can include spending limits such as dollar value of a single purchase, dollar value for a given time period (day, week, etc.), number of purchases (which can be independent of or in connection with dollar value), and maximum per transaction. The parameters can dictate a schedule for which certain recurrences take place, for monthly payments and other such scheduled expenses. The parameters can also include locations in which certain transactions can take place. The parameters can restrict spending to certain vendors or vendor types, such as lodging, or travel, etc. The identity of the card holder can be described in the budget parameters. There can be any number of parameters in the budgets.

The budgeting module 236 can include a communications module 235 that is able to communicate the budgets to a Transaction Authorization System 204 which can be a card issuer, a bank, an underwriter, or another party or institution responsible for carrying out purchases made with the cards. In response to the budgets and budget parameters, the Transaction Authorization System 204 can alter the configuration of the cards 232, 234 in real time and in response to inputs received from the employer 204 or employees 228, 230. One example useful for explanation is the spending limit for a card. The standard credit card configuration involves a credit limit or spending limit for the individual which occasionally changes, but such changes are done monthly or annually and not in response to inputs from a budgeting module as described herein. In the embodiments shown in FIG. 8, the card limits as stored in the memory 214 of the Transaction Authorization System 204 are changed in response to the instructions from the budgeting module 236 which receives the instructions from the employer 200. The system can also include an expenditure module 237 which can reside on a mobile computing device having wireless capabilities held by the employee 228. Through the expenditure module 237 the employee 238 can select a budget from which a transaction will draw. In some embodiments the card 234 is a virtual card which resides on the expenditure module 237. There may be any number of budgets available and the selection of a budget informs the Transaction Authorization System 204 which parameters to apply to the transaction.

To illustrate how such a system may be utilized, consider the following situation: An employer wants to send an employee out on a client visit. The employee has a card which is issued by a card issuer who has mechanisms in place to effect transactions on the card (Transaction Authorization System 204). The employer, via a smartphone or desktop computing device, can enter parameters that dictate how the cards are to be used. In this case, the employer may want to limit the spending during the client visit not to exceed $500.00, and spending is only allowed during the hours preceding and following the visit. The employer may set up via the budgeting module 236 the time during which the card is allowed to be used, and the spending limit. This information is conveyed to the Transaction Authorization System 204 and the card is usable only under these circumstances. The employer can implement virtually any suitable limit as a parameter for the budget and the cards will be effective only according to the parameters.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

1. A system for managing expenditures using a card, comprising:
a budgeting module configured to receive a budget having a plurality of parameters describing conditions under which the card may be used; and
a communications module configured to transmit the parameters to a card issuer, wherein the card issuer issues the card, manages expenditures made with the card, and maintains an account pertaining to the card, wherein the card issuer reconfigures the account according to the parameters such that expenditures are allowed so long as the expenditures are made according to the parameters.

2. The system of claim 1 wherein the parameters include a spending limit for expenditures.

3. The system of claim 1 wherein the parameters include one or more accepted vendors.

4. The system of claim 1 wherein the parameters include a recurring schedule of expenditures.

5. The system of claim 1 wherein the parameters include a time of the expenditures.

6. The system of claim 5 wherein the time of expenditures comprises a time period having a beginning and an ending time between which expenditures may be made.

7. The system of claim 1 wherein the parameters include a category of vendor.

8. The system of claim 7 wherein the budgeting module is configured to receive inputs that determine the category of vendor.

9. The system of claim 1 wherein the parameters include a location of the expenditure.

10. The system of claim 1, further comprising an expenditure module configured to receive a selection of one or more budgets and inform the card issuer of the selection, wherein the card issuer reconfigures the account according to the parameters of the selected budget.

11. A method for managing expenses, comprising:
establishing an account and issuing a card for making purchases using the account;
receiving one or more budgets, wherein individual budgets include a plurality of parameters dictating conditions for use of the card, wherein the budgets and parameters are stored in a memory;
receiving a selection of a budget;
accessing the parameters in the budget from the memory; and
reconfiguring the account according to the parameters in the selected budget.

12. The method of claim 11, further comprising receiving an updated budget including one or more updated parameters.

13. The method of claim 11 wherein reconfiguring the account is performed in less than five minutes.

14. The method of claim 11 wherein the parameters include a location.

15. The method of claim 11 wherein the parameters include a time period.

16. The method of claim 11 wherein the parameters include accepted vendors.

17. The method of claim 11 wherein the parameters include a category of accepted vendors.

18. The method of claim 17, the method further comprising receiving a category of accepted vendors.

19. The method of claim 11, further comprising identifying a default budget that is active unless another budget is selected.

20. A method, comprising:
receiving one or more budgets, wherein individual budgets have one or more parameters, wherein the parameters identify conditions under which a transaction can be made using a card, the parameters including at least a maximum credit line associated with an account from which the card draws, and a time during which the budget is active;
receiving a selection of a budget from among the budgets;
when the time is reached, applying the parameters from the selected budget to reconfigure the account;
receiving transaction details from a point of sale; and
if the transaction details are in accordance with the parameters in the selected budget, allowing the transaction to be executed.

21. The method of claim 20, the method further comprising requiring authentication for receiving the one or more budgets.

22. The method of claim 20, the method further comprising requiring authentication for receiving a selection of the budget from among the budgets.

23. The method of claim 20 wherein one of the budgets is a default budget that is active unless another budget is active.

24. The method of claim 20, the method further comprising rejecting the transaction if no budget is selected.

25. The method of claim 20, the method further comprising updating one or more budgets after a transaction is complete.
